(19) United States
(12) Patent Application Publication
(10) Pub. No.: US 2005/0215212 A1
(43) Pub. Date: Sep. 29, 2005

(54) Receiver

(75) Inventor: Kazuya Uryu, Tokyo (JP)

Correspondence Address: BIRCH STEWART KOLASCH & BIRCH, PO BOX 747, FALLS CHURCH, VA, 22040-0747, US

(73) Assignee: Mitsubishi Denki Kabushiki Kaisha

(21) Appl. No.: 11/052,919

(22) Filed: Feb. 9, 2005

(30) Foreign Application Priority Data
Mar. 26, 2004 (JP) 2004-92632

(51) Int. Cl. H04B 1/18

(52) U.S. Cl. 455/165.1

(57) ABSTRACT

An RF level detector 33 adjusts an RF receive level according to a selected threshold, and a plurality of level detectors 31d to 31f detect the levels of signal waves so as to acquire signal wave detection levels, respectively. A C/N determining unit 26a detects a carrier-to-noise ratio for each of the signal waves, and outputs a C/N determination value as signal wave receive sensitivity. A microcomputer 32 selects the threshold which is provided to the RF level detector 33 according to the signal wave detection levels and the C/N determination values, and performs a receive control operation on a desired wave.

### BACKGROUND OF THE INVENTION

1. Field of the Invention

The present invention relates to a receiver that can remove interference caused by interference waves that originate from electric waves in an adjacent frequency band, and can receive a desired electric wave with a high degree of precision.

2. Description of Related Art

In general, receivers need to remove interference caused by interference waves that originate from electric waves in an adjacent frequency band in order to receive a desired electric wave with a high degree of precision. For example, receivers need to prevent the desired wave from receiving interference due to an intermodulation distortion which occurs in a frequency close to that of the interference waves, thereby preventing the receive status of the desired wave from getting worse. Therefore, receivers are generally so constructed as to reduce interference caused by interference waves using an automatic gain control (AGC) circuit.

In order to reduce interference caused by interference waves, a receiver separately performs both a wide band AGC and a narrow band AGC, reduces the gain of a high-frequency amplifier by using the wide band AGC when the levels of the interference waves become high, and holds the output voltage of an intermediate frequency amplifying circuit at a fixed level by using the narrow band AGC when the electric field strength of the desired wave becomes larger than a predetermined value.

In this case, the receiver compares the levels of the desired wave and the interference waves with first and second reference voltages, respectively, and, when determining that the level of the desired wave is lower than the first reference voltage and the levels of the interference waves are higher than the second reference voltage, and performs an AGC operation on the high-frequency amplifier according to the detected levels of the interference waves, thereby preventing the interference waves from interfering into the desired wave when the level of the desired wave is low (refer to patent reference 1, for example).

[Patent reference 1] JP,60-152111,A (see pp. 2 to 4 and FIGS. 1 to 4)

A problem with the related art receiver constructed as mentioned above is however that in a case where two or more signal waves via which the same contents are transmitted to the receiver exist, and the receiver selects and receives, as a desired wave, a signal wave having good receive sensitivity from the two or more signal waves, when the levels of interference waves become high, even if the receiver performs a wide band AGC operation so as to reduce the gain of the high-frequency amplifier, as mentioned above, an intermodulation distortion caused by the adjacent interference waves may occur unavoidably for all the two or more signal waves and the receiver cannot consequently receive neither of all the signal waves with a high degree of precision if the difference in frequency between the two or more signal waves and the interference waves is small.

Another problem with the related art receiver is that in a case where two or more signal waves via which the same contents are transmitted to the receiver exist, even if the receiver tries to select and receive, as the desired wave, a signal wave having good receive sensitivity from the two or more signal waves, the receiver cannot perform gain control according to a relationship between the adjacent interference waves and the two or more signal waves on a frequency axis, and cannot therefore select and receive, as the desired wave, a signal wave having good receive sensitivity from the two or more signal waves.

### SUMMARY OF THE INVENTION

The present invention is made in order to solve the above-mentioned problems, and it is therefore an object of the present invention to provide a receiver that, when selecting and receiving, as a desired wave, a signal wave having good receive sensitivity from two or more signal waves via which the same contents are transmitted thereto, can select the desired wave with a simplified structure and can perform a receiving operation on the desired wave under good conditions.

In accordance with the present invention, there is provided a receiver including: a receive level adjusting unit for, when the receiver receives, as a desired wave, one of two or more signal waves having different frequencies and providing identical contents, and then outputs the desired wave, adjusting an RF receive level according to a selected threshold; a level detecting unit for detecting a level of each of the two or more signal waves so as to acquire a signal wave detection level for each of the two or more signal waves; a receive sensitivity detecting unit for detecting receive sensitivity of each of the two or more signal waves so as to signal wave receive sensitivity for each of the two or more signal waves; and a control unit for selecting the threshold that is provided to the receive level adjusting unit according to the signal wave detection level and the signal wave receive sensitivity, and for performing a receive control operation on the desired wave.

As mentioned above, when receiving, as a desired wave, one of two or more signal waves having different frequencies and providing identical contents, and then outputting the desired wave, the receiver in accordance with the present invention detects a level of each of the two or more signal waves so as to acquire a signal wave detection level for each of the two or more signal waves and also detects receive sensitivity of each of the two or more signal waves so as to acquire signal wave receive sensitivity for each of the two or more signal waves, and selects the threshold that is provided to the receive level adjusting unit according to the signal wave detection level and the signal wave receive sensitivity. Therefore, the present invention offers an advantage of being able to reduce the influence of interference waves upon the desired wave to a minimum, thereby enabling the selection of the desired wave with the simplified structure and the performance of a receiving operation under good conditions.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing an example of arrangement of two or more satellite digital radio broadcast signals on a frequency axis;

FIG. 2 is a diagram showing an example of interference caused by interference waves, which a desired radio broadcast wave receives;

FIG. 3 is a diagram showing the structure of an example of an RF-stage circuit used for improving an intermodulation distortion caused by interference waves;

FIG. 4 is a block diagram showing a receiver in accordance with embodiment 1 of the present invention;

FIG. 5 is a block diagram showing in detail an example of the receiver shown in FIG. 4;

FIG. 6 is a flow chart for explaining the operation of the receiver shown in FIG. 5;

FIG. 7 is a diagram showing a state where the influence of the interference waves is reduced in the receiver shown in FIG. 5;

FIG. 8 is a block diagram showing in detail another example of the receiver shown in FIG. 4; and

FIG. 9 is a block diagram showing in detail a further example of the receiver shown in FIG. 4.

### DETAILED DESCRIPTION OF THE PREFERRED EMBODIMENTS

### Embodiment 1

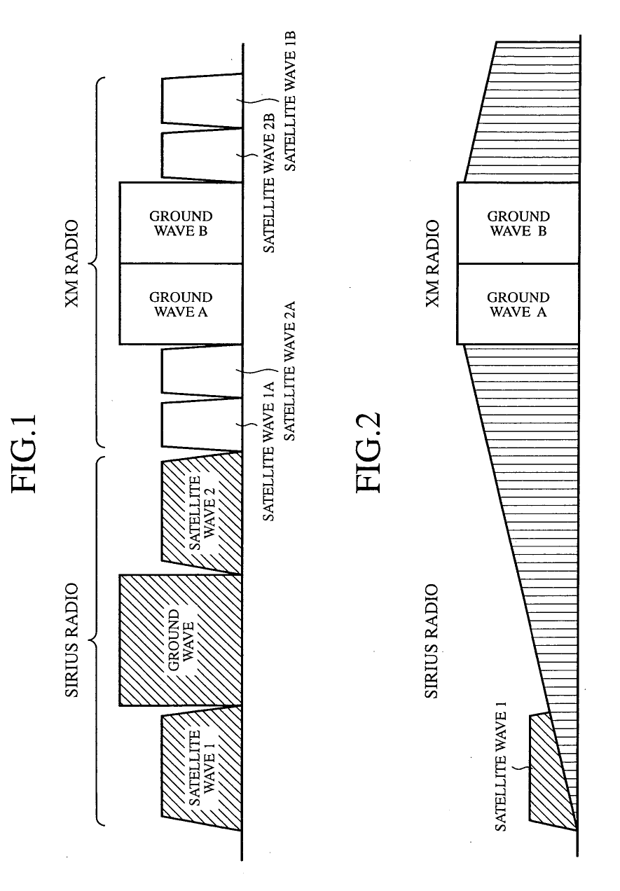

A receiver in accordance with this embodiment will be explained hereafter by taking, as an example, a radio receiver for receiving a satellite digital radio broadcast signal. In FIG. 1, in a SIRIUS radio broadcast system in the U.S. which is a satellite digital radio broadcast system, radio broadcast signals (i.e., signal waves) are transmitted in order of a satellite wave 1 and a satellite wave 2 via which the same radio broadcast program is broadcast. These satellite waves 1 and 2 are arranged successively on a frequency axis. A ground wave is positioned in a band between the satellite wave 1 and the satellite wave 2 so that the SIRIUS radio broadcast system can deal with radio receive interference caused by buildings etc.

In FIG. 1, a band of frequencies that are higher than and adjacent to those assigned to the SIRIUS radio broadcasting is assigned to XM radio broadcasting, and the frequencies in the frequency band for this XM radio broadcasting are assigned to a satellite wave 1A, a satellite wave 2A, a ground wave A, a ground wave B, a satellite wave 2B, and a satellite wave 1B in order of these waves, for example. The ground waves A and B may serve as interference waves that interfere with the SIRIUS radio broadcasting, as will be mentioned later.

In accordance with embodiment 1, the SIRIUS satellite waves are signal waves and the XM ground waves are interference waves. Since the same broadcast program is transmitted via the satellite wave 1 and the satellite wave 2 included in the SIRIUS satellite waves, the radio receiver of this embodiment only has to receive either one of the satellite wave 1 and the satellite wave 2.

For example, when the receive level of an XM ground wave is large, that is, when an RF stage of the radio receiver has a large gain while the radio receiver is receiving a SIRIUS satellite wave, an intermodulation distortion at a frequency range close to that of the XM ground wave occurs in the radio receiver, especially in a low noise amplifier (LNA) or a frequency converter (D/C: DownConverter). As a result, the XM ground wave interferes with the SIRIUS satellite wave and therefore the receive status of the SIRIUS satellite wave gets worse, as shown in FIG. 2. Therefore, in order to receive the above-mentioned SURIUS satellite wave (i.e., the satellite wave 1 or 2) under good conditions, the radio receiver of this embodiment needs to prevent interference from the XM ground waves.

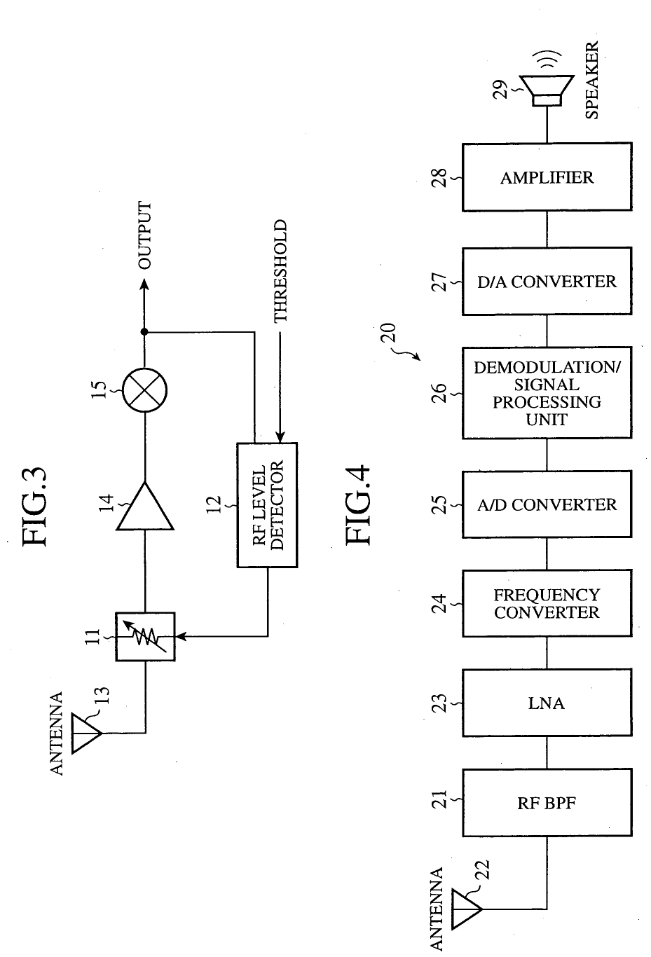

In order to improve such an intermodulation distortion, an AGC circuit is disposed in the RF stage of the radio receiver, as shown in FIG. 3. The AGC circuit shown in this figure has a variable attenuator 11 and an RF level detector 12, sends an input signal (i.e., an RF signal) from an antenna 13 to the LNA 14 via the variable attenuator 11, and then outputs an output of the LNA14, as an output of the RF stage, via the D/C 15.

The output of the D/C 15 is also provided to the RF level detector 12, and the RF level detector 12 adjusts the amount of attenuation of the variable attenuator 11 so as to reduce the gain of the RF stage when the output level of the D/C 15 is large and exceeds a predetermined threshold level (i.e., a predetermined threshold).

The AGC circuit thus reduces the gain of the RF stage of the radio receiver when the output level of the D/C 15 exceeds the predetermined threshold level. As a result, although the intermodulation distortion resulting from the interference waves is reduced, the carrier-to-noise ratio (C/N) of each of the satellite waves 1 and 2 is also reduced simultaneously. In other words, it is difficult to prevent reduction of the C/N of each of the satellite waves 1 and 2 while reducing the intermodulation distortion.

In FIG. 1, the frequency band for the XM radio broadcasting is located at a higher frequency range than that for the SIRIUS radio broadcasting. In addition, a frequency band for other radio broadcasting can be located at a lower frequency range than that for the SIRIUS radio broadcasting. In accordance with this embodiment 1, as will be mentioned later, the radio receiver determines whether the frequencies of the interference waves are located at a frequency band higher or lower than those of the signal waves (via the SIRIUS radio broadcasting), and defines, as a desired wave, a signal wave having the highest receive sensitivity among the two or more signal waves so as to reduce the influence of the interference waves upon the desired wave to a minimum.

Although the above explanation is directed to the interference from interference waves at a time of receiving satellite waves, the radio receiver of this embodiment can be also applied to a case of receiving electric waves via radio broadcasting or the like. In such a case, even when selectively receiving a desired wave from two or more signal waves providing the same contents and being arranged successively on the frequency axis, the radio receiver of this embodiment can define, as the desired wave, a signal wave having the highest receive sensitivity among the two or more electric waves so as to reduce the influence of interference waves upon the desired wave to a minimum.

Referring now to FIG. 4, the radio receiver 20 according to embodiment 1 is provided with a RF band pass filter (or RF BPF) 21. The RF BPF 21 filters electric waves (for example, SIRIUS satellite waves (i.e., a satellite wave 1, a satellite wave 2, and a groundwave)) received via an antenna (ANT) 22, a LNA 23 amplifies the filtered electric waves and a D/C 24 converts the amplified electric wave into an intermediate frequency (IF) signal. After that, an A/D converter (ADC) 25 converts this IF signal into a digital signal, and a demodulation/signal processing unit (DEM) 26 performs signal processing, which will be mentioned later, on the digital signal while performing demodulation processing on the digital signal.

The digital signal on which the demodulation processing is performed by the DEM 26 (i.e., the demodulated signal) is then converted into an analog signal by a D/A converter (DAC) 27, and is outputted via a speaker (SP) 29, as a voice or a sound, after being amplified by an amplifier (AMP) 28.

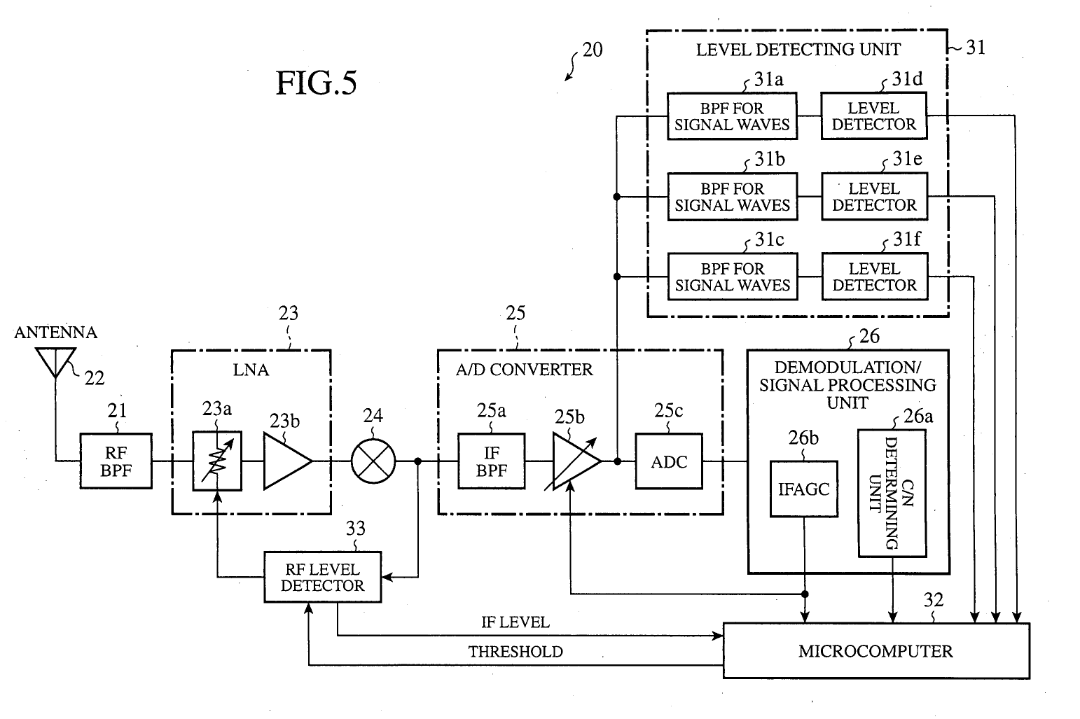

Referring next to FIG. 5, the radio receiver 20 is further provided with a level detecting unit 31 and a microcomputer 32, and the DEM 26 is provided with both a C/N determining unit 26a and an IF automatic gain control circuit (IFAGC) 26b as a signal processing function. Although not shown in FIG. 4, the radio receiver 20 is provided with an RF level detector 33, as shown in FIG. 5. In the example shown in FIG. 5, the LNA 23 shown in FIG. 4 has a variable attenuator 23a and an LNA 23b, and the ADC 25 shown in FIG. 4 has an IF BPF 25a, a variable amplifier 25b, and an ADC 25c.

The variable attenuator 23a, the LNA 23b, and the D/C 24 constitute the RF stage, and the RF level detector 33 receives the output (i.e., the IF signal) of the D/C 24, detects the IF level of the output of the D/C 24, and then adjusts the amount of attenuation of the variable attenuator 23a according to a threshold preset by the microcomputer 32. The RF level detector 33 then delivers the detected IF level to the microcomputer 32.

In the example shown in FIG. 5, the level detecting unit 31 has first through third BPFs 31a to 31c. These first through third BPFs 31a to 31c correspond to the satellite wave 1, the satellite wave 2, and the ground wave, respectively, and allow the satellite wave 1, the satellite wave 2, and the ground wave to pass therethrough, respectively. First through third level detectors 31d to 31f are connected to the first through third BPFs 31a to 31c, respectively. The first through third level detectors 31d to 31f detect the receive levels of the satellite wave 1, the satellite wave 2, and the ground wave, respectively, and output the detected receive levels (i.e., signal wave detection levels) of those waves to the microcomputer 32 (the detected receive levels outputted from the first through third level detectors 31d to 31f are referred to as first through third detected receive levels, respectively).

The C/N determining unit 26a determines a C/N level for each of the satellite wave 1, the satellite wave 2, and the ground wave, and then provides first through third determined C/N levels (i.e., C/N determination values) to the microcomputer 32 (the determination of the C/N levels of the satellite wave 1, the satellite wave 2, and the ground wave means the determination of the receive sensitivity of the satellite wave 1, the satellite wave 2, and the ground wave). As will be mentioned later, the microcomputer 32 changes the threshold provided to the RF level detector 33, and the IFAGC 26b sets an amplification level of the variable amplifier 25b.

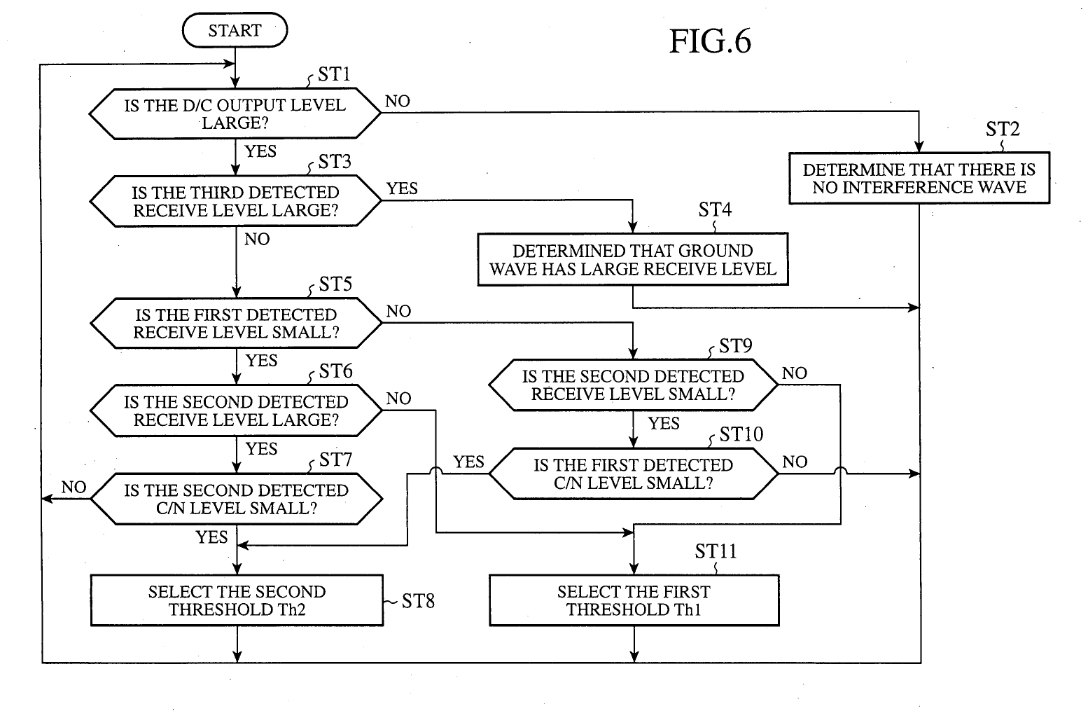

Next, the operation of the radio receiver in accordance with this embodiment of the present invention will be explained. Referring to FIGS. 5 and 6, first and second thresholds Th1 and Th2 (the first threshold Th1>the second threshold Th2) are preset to the microcomputer 32. When the radio receiver 20 is turned on, the microcomputer 32 determines whether or not the IF level of the output of the D/C 24 is larger than a predetermined reference level (in step ST1). When determining that the IF level is smaller than the predetermined reference level, the microcomputer 32 determines that there is little interference from interference waves (or there is no interference wave) (in step ST2), and then keeps the radio receiver 20 in a current state.

On the other hand, when, in step ST1, determining that the IF level of the output of the D/C 24 is larger than the predetermined reference level, the microcomputer 32 further determines whether or not the third detected receive level is larger than a predetermined reference receive level (in step ST3). When determining that the third detected receive level is larger than the predetermined reference receive level, the microcomputer 32 determines that the ground wave (i.e., a reselected one of the two or more signal waves) of the SIRUIS radio broadcasting has a large receive level (in step ST4), and then receives the ground wave which keeps the radio receiver 20 in the current state.

When, in step ST3, determining that the third detected receive level is not larger than the predetermined reference receive level (i.e., when determining that the third detected receive level is equal to or smaller than the predetermined reference receive level), the microcomputer 32 determine that interference waves have a large level, and further determines whether or not the first detected receive level is smaller than a predetermined reference receive level (in step ST5). When determining that the first detected receive level is smaller than the predetermined reference receive level (i.e., when determining that the satellite wave 1 has a small receive level), the microcomputer 32 further determines whether or not the second detected receive level is larger than a predetermined reference receive level (in step ST6).

When, in step ST6, determining that the second detected receive level is larger than the predetermined reference receive level (i.e., when determining that the satellite wave 2 has a large receive level), the microcomputer 32 further determines whether or not the second determined C/N level is smaller than a reference C/N level (in step ST7). When determining that the second determined C/N level is smaller than the reference C/N level, the microcomputer 32 determines that interference waves are located in a range of frequencies higher than those of the frequency band for the SIRUIS radio broadcasting, selects the second threshold Th2, and then provides the second threshold Th2 to the RF level detector 33 (in step ST8).

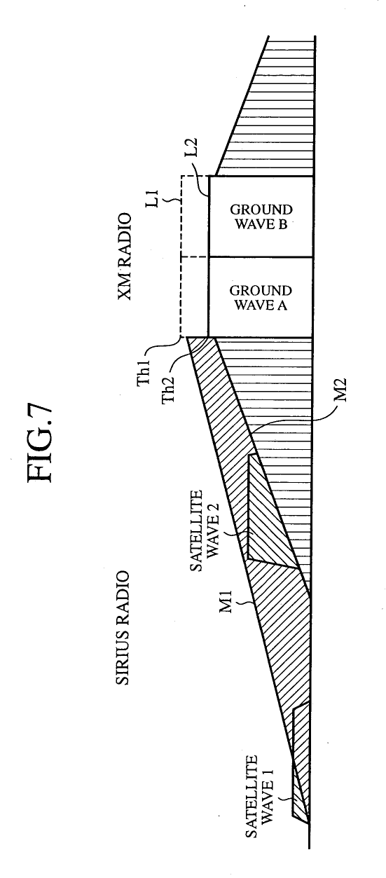

When determining that interference waves are located in a range of frequencies higher than those of the frequency band for the SIRUIS radio broadcasting, the microcomputer 32 determines that the ground waves A and B which are XM radio broadcast waves interfere with the SIRIUS radio broadcast waves, as shown by a segment M1 of FIG. 7, for example. When the microcomputer 32 provides the second threshold Th2 to the RF level detector 33, the RF level detector 33 compares the level (i.e., the IF level) of the IF signal with the second threshold Th2. When the IF level is larger than the second threshold Th2, the RF level detector 33 adjusts the amount of attenuation of the variable attenuator 23a so that the IF level becomes equal to or smaller than the second threshold Th2.

As shown in FIG. 7, when the first threshold Th1 is selected, while the receive levels of the ground waves A and B which are XM radio broadcast waves are reduced to a receive level L1 shown by a dashed line of the figure, the ground waves A and B which are XM radio broadcast waves perfectly interfere with the satellite wave 2 which is a SIRIUS radio broadcast wave, and also interfere with the satellite wave 1. Although the satellite wave 2 is selected as the desired wave when the receive level of the satellite wave 1 is small, it is difficult for the radio receiver to receive and demodulate the satellite wave 2 because a large influence of the interference waves is exerted upon the satellite wave 2.

In contrast, when the microcomputer 32 selects the second threshold Th2, as mentioned above, the receive levels of the ground waves A and B which are XM radio broadcast waves are reduced to a receive level L2 shown by a solid line of FIG. 7, and therefore the interference of the ground waves A and B upon the satellite wave 2 can be reduced as shown by a segment M2 of FIG. 7. As a result, when the satellite wave 2 is selected as the desired wave, the radio receiver can receive and demodulate the desired wave under good conditions.

On the other hand, when, in step ST5, determining that the first detected receive level is not smaller than the reference receive level (i.e., when determining that the first detected receive level is equal to or larger than the reference receive level), the microcomputer 32 further determines whether or not the second detected receive level is smaller than a reference receive level (in step ST9). When determining that the second detected receive level is smaller than the predetermined reference receive level, the microcomputer 32 further determines whether or not the first determined C/N level is smaller than a reference C/N level (in step ST10). When determining that the first determined C/N level is smaller than the reference C/N level, the microcomputer 32 determines that interference waves are located in a range of frequencies lower than those of the frequency band for the SIRUIS radio broadcasting, in step ST8, selects the second threshold Th2, and then provides the second threshold Th2 to the RF level detector 33.

Also in a case where interference waves exist at a range of frequencies lower than those of the SIRUIS radio broadcast waves, when the microcomputer 32 selects the second threshold Th2, the receive levels of the interference waves decrease and hence the influence of the interference waves upon the satellite wave 1 which is an SIRUIS radio broadcast wave decreases, so that the radio receiver can receive and demodulate the satellite wave 1 under good conditions.

When, in step ST6, determining that the second detected receive level is not larger than the reference receive level (i.e., determining that the second detected receive level is equal to or smaller than the reference receive level), the microcomputer 32 selects the first threshold Th1 (in step ST11). In other words, since both the first and second detected receive levels are smaller than the corresponding reference receive levels, respectively, in this case, the microcomputer 32 selects the first threshold Th1 and raises the receive levels of the satellite waves 1 and 2 which are SIRIUS radio broadcasting waves regardless of the interference waves. When, in step ST9, determining that the second detected receive level is equal to or larger than the reference receive level, the microcomputer 32 selects the first threshold Th1. In other words, since both the first and second level detected receive levels are equal to or larger than the corresponding reference receive levels, respectively, in this case, the microcomputer 32 selects the first threshold Th1 and raises the receive levels of the satellite waves 1 and 2.

When, in step ST7, determining that the second determined C/N level is not smaller than the reference C/N level (i.e., determining that the second determined C/N level is equal to or larger than the reference C/N level), the microcomputer 32 keeps the radio receiver 20 in the current state. Similarly, when, in step ST10, determining that the first determined C/N level is not smaller than the reference C/N level (i.e., determining that the first determined C/N level is equal to or larger than the reference C/N level), the microcomputer 32 keeps the radio receiver 20 in the current state.

As can be seen from the above explanation, the RF level detector 33 functions as a receive level adjusting means, and the level detecting unit 31 functions as a level detecting means. The C/N determining unit 26a functions as a receive sensitivity detecting means, and the microcomputer 32 functions as a control means.

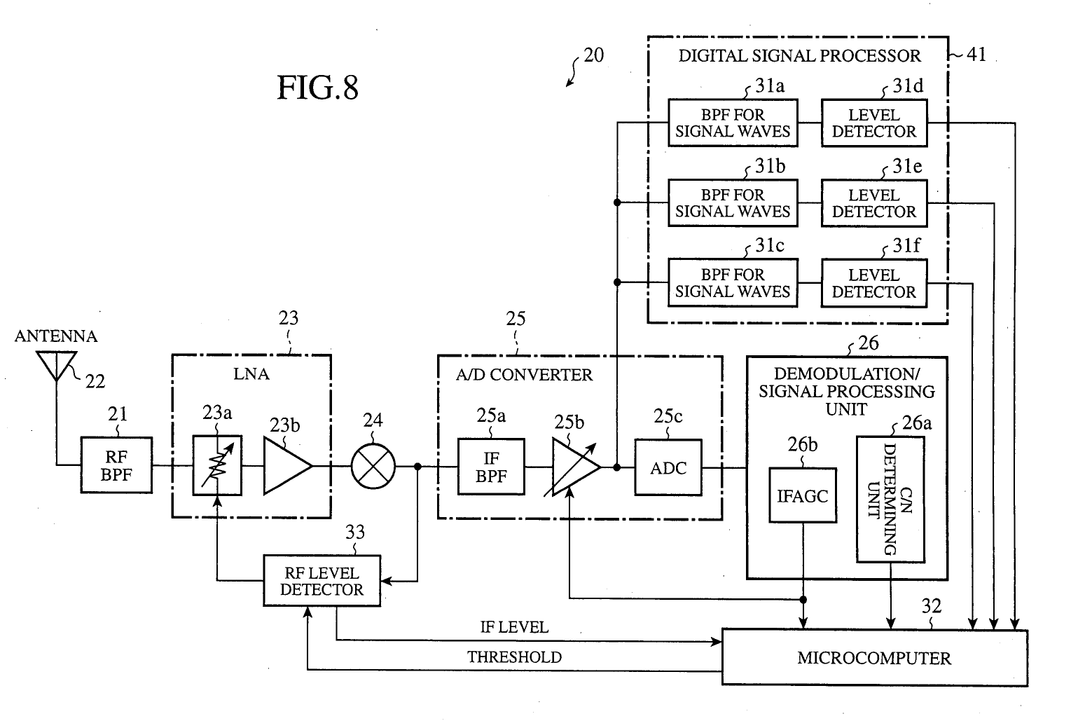

FIG. 8 is a block diagram showing in detail another example of the receiver shown in FIG. 4. In the figure, the same reference numerals as shown in FIG. 5 denote the same components as shown in FIG. 5, respectively. In the example shown, the radio receiver has a digital signal processor (DSP) 41, and a digitized IF signal from the ADC 25c is inputted into the DSP 41. The functions of the first through third BPFs 31a to 31c and the functions of the first through third level detectors 31d to 31f are implemented by the DSP 41. Since the receiver of FIG. 8 operates in the same way as previously explained with reference with FIGS. 5 and 6, the explanation of the operation of the receiver of FIG. 8 will be omitted hereafter.

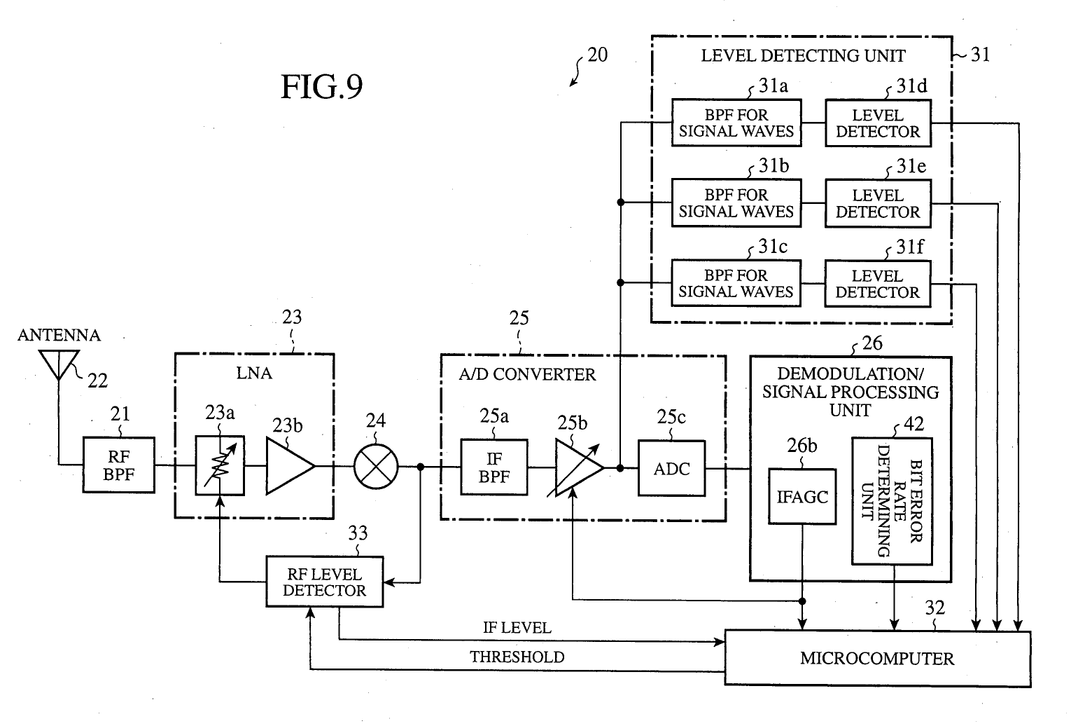

FIG. 9 is a block diagram showing in detail a further example of the receiver shown in FIG. 4. The DEM 26 of the receiver shown in FIG. 9 is provided with a bit error rate (BER) determining unit 42 instead of the C/N determining unit 26a shown in FIG. 5. The BER determining unit 42 measures a bit error rate for each of the satellite wave 1, the satellite wave 2, and the ground wave of the SIRIUS radio broadcasting so as to acquire first through third BER determination values, and then provides these first through third BER determination values to the microcomputer 32. The measurement of the BER determination values for the satellite wave 1, the satellite wave 2, and the ground wave means the determination of the receive sensitivity of the satellite wave 1, the satellite wave 2, and the ground wave.

The radio receiver shown in FIG. 9 operates in the same way as previously explained with reference with FIGS. 5 and 6, with the exception that the microcomputer 32 selects either the first threshold Th1 or the second threshold Th2 by using the first and second BER determination values instead of the first and second C/N determination values.

Needless to say that in the example shown in FIG. 8, the receiver is provided with the BER determining unit 42 instead of the C/N determining unit 26a.

As mentioned above, when receiving broadcast waves including two or more signal waves that provide the same broadcast contents, the receiver according to this embodiment 1 acquires the receive levels of the two or more signal waves, acquires the C/N levels of the two or more signal waves, determines whether or not interference waves exist in the vicinity of the broadcast waves according to the acquired receive levels and the acquired C/N levels, and, when interference waves exist in the vicinity of the broadcast waves, reduces the influence of the interference waves upon a desired wave to a minimum. Therefore, the present embodiment offers an advantage of being able to perform reception and demodulation on the desired wave under good conditions.

Furthermore, when the level of the IF signal from the D/C is small, the receiver according to this embodiment 1 determines that the interference waves have low receive levels and it is assumed that there are noninterference waves. Therefore, the present embodiment offers another advantage of being able to judge whether interference waves exist with a simplified structure.

In addition, when the first detected receive level which is the detected receive level of a signal wave having the lowest frequency is smaller than the corresponding reference receive level and the second detected receive level which is the detected receive level of a signal wave having the highest frequency is larger than the corresponding reference receive level, the receiver according to this embodiment 1 determines that the interference waves exist in a range of frequencies higher than those of the broadcast waves and then lowers the threshold if the second detected C/N level which is the detected C/N level of the signal wave having the highest frequency is smaller than the corresponding reference C/N level. Therefore, the present embodiment offers a further advantage of being able to reduce the influence of the interference waves upon a frequency range (i.e., the desired wave) closest to those of the interference waves, thereby enabling reception and demodulation of the desired wave under good conditions.

In addition, when the first detected receive level which is the detected receive level of the signal wave having the lowest frequency is larger than the corresponding reference receive level and the second detected receive level which is the detected receive level of the signal wave having the highest frequency is smaller than the corresponding reference receive level, the receiver according to this embodiment 1 determines that the interference waves exist in a range of frequencies lower than those of the broadcast waves and then lowers the threshold if the first detected C/N level which is the detected C/N level of the signal wave having the lowest frequency is smaller than the corresponding reference C/N level. Therefore, the present embodiment offers a further advantage of being able to reduce the influence of the interference waves upon a frequency range (i.e., the desired wave) closest to those of the interference waves, thereby enabling reception and demodulation of the desired wave under good conditions.

Many widely different embodiments of the present invention may be constructed without departing from the spirit and scope of the present invention. It should be understood that the present invention is not limited to the specific embodiments described in the specification, except as defined in the appended claims.

1. A receiver for receiving, as a desired wave, one of two or more signal waves having different frequencies and providing identical contents, and for outputting the desired wave, said receiver comprising:
a receive level adjusting means for adjusting an RF receive level according to a selected threshold;
a level detecting means for detecting a level of each of said two or more signal waves so as to acquire a signal wave detection level for each of said two or more signal waves;
a receive sensitivity detecting means for detecting receive sensitivity of each of said two or more signal waves so as to acquire signal wave receive sensitivity for each of said two or more signal waves; and
a control means for selecting the threshold that is provided to said receive level adjusting means according to the signal wave detection levels and signal wave receive sensitivities of said two or more signal waves, and for performing a receive control operation on said desired wave.

2. The receiver according to claim 1, wherein said receive level adjusting means includes at least a variable attenuator, a frequency converter located behind said variable attenuator, and a level detector for determining the RF receive level based on an output of said frequency converter, and for adjusting an attenuation of said variable attenuator according to the threshold selected by said control means, and wherein said control means determines that no interference wave exists when said RF receive level is smaller than a predetermined receive level.

3. The receiver according to claim 1, wherein when determining that the signal wave detection level corresponding to a predetermined one of said two or more signal waves is larger than a reference value, said control means performs receive control so as to receive the predetermined signal wave as the desired wave.

4. The receiver according to claim 3, wherein said control means has at least a first threshold and a second threshold smaller than said first threshold, and, when signal wave detection levels corresponding to signal waves having lower frequencies of said two or more signal waves are smaller than the reference value and signal wave detection levels corresponding to signal waves having higher frequencies of said two or more signal waves are larger than the reference value, provides said second threshold to said receive level adjusting means if signal wave receive sensitivities corresponding to the signal waves having higher frequencies are smaller than a reference value.

5. The receiver according to claim 3, wherein said control means has at least a first threshold and a second threshold smaller than said first threshold, and, when signal wave detection levels corresponding to signal waves having lower frequencies of said two or more signal waves are larger than the reference value and signal wave detection levels corresponding to signal waves having higher frequencies of said two or more signal waves are smaller than the reference value, provides said second threshold to said receive level adjusting means if signal wave receive sensitivities corresponding to the signal waves having higher frequencies are smaller than a reference value.

6. The receiver according to claim 3, wherein said control means has at least a first threshold and a second threshold smaller than said first threshold, and, when both signal wave detection levels corresponding to signal waves having lower frequencies of said two or more signal waves and signal wave detection levels corresponding to signal waves having higher frequencies of said two or more signal waves are smaller than the reference value, provides said first threshold to said receive level adjusting means.

7. The receiver according to claim 3, wherein said control means has at least a first threshold and a second threshold smaller than said first threshold, and, when both signal wave detection levels corresponding to signal waves having lower frequencies of said two or more signal waves and signal wave detection levels corresponding to signal waves having higher frequencies of said two or more signal waves are larger than the reference value, provides said first threshold to said receive level adjusting means.

8. The receiver according to claim 1, wherein said receive sensitivity detecting means measures a carrier-to-noise ratio for each of the two or more signal waves so as to acquire a C/N determination value as the signal wave receive sensitivity for each of the two or more signal waves.

9. The receiver according to claim 1, wherein said receive sensitivity detecting means determines a bit error rate for each of the two or more signal waves so as to acquire a BER determination value as the signal wave receive sensitivity for each of the two or more signal waves.
